(19) United States
(12) Patent Application Publication
(10) Pub. No.: US 2008/0086377 A1
(43) Pub. Date: Apr. 10, 2008

(54) METHOD AND SYSTEM FOR MANAGING CUSTOMERS DURING PEAK OR BUSY HOURS FOR RESTAURANTS AND OTHER INDUSTRIES

(76) Inventor: Rajesh Jain, New Delhi (IN)

Correspondence Address: LADAS & PARRY LLP, 26 WEST 61ST STREET, NEW YORK, NY, 10023, US

(21) Appl. No.: 11/865,741

(22) Filed: Oct. 2, 2007

Related U.S. Application Data
(60) Provisional application No. 60/849,315, filed on Oct. 4, 2006.

(51) Int. Cl. G06Q 30/00; G06Q 50/00

(52) U.S. Cl. 705/14

(57) ABSTRACT

The invention describes a method and system for managing customers in a restaurant and similar service providing industries. Particularly it relates to accommodating more number of customers during peak or busy hours. The time spent by a customer at a table is reduced by providing an appropriate incentive, thereby reducing the wait time of customers waiting in the queue.

### CROSS-REFERENCE TO RELATED APPLICATION

This application claims the benefit of U.S. Provisional Patent Application No. 60/849,315 filed Oct. 4, 2006, which is hereby incorporated by reference in its entirety.

### TECHNICAL FIELD

The invention relates to a method and system for managing customers in a restaurant and similar service providing industries. Particularly the invention relates to a method and system for managing and accommodating more number of customers during peak or busy hours.

### BACKGROUND OF THE INVENTION

Generally, restaurants run packed to their capacity during the peak or busy hours that are particularly during the lunch time and dinner. More frequently, the restaurants, food courts, fast food centers, hotels are packed during this time as many customers visit the restaurants during such time. This results in customers waiting in a queue until they manage a place to have food.

It is frequently noted that people conveniently spend more time on the table during and even after eating in restaurants and hotels. This causes inconvenience to the other people who wait in a queue especially during peak or busy hours when people have to return to work or business within a stipulated time.

Furthermore, it becomes difficult for the restaurant or hotel managers to satisfy both the customers who wait and those who spend time on the table.

Many methods have been developed that reduces the time spent on the table to reduce the wait time in the queue.

Some restaurants, hotels, food-courts, fast food centers and the like have “quick-menus” for the convenience of customers during peak or busy hours. Such “quick menus” may or may not be preferred by most customers.

Japanese Patent Publication JP01263867 entitled “Restaurant System” describes a keyboard device set on each table on a seat floor and at the same time a kitchen printer set at a kitchen. An electronic cash register is set at an accounting place as an accounting machine. Then on-line connection is secured among the device of the table, the printer and the register via a communication circuit. The order data inputted via the device are sent to the register as well as the printer together with identification information set at the device. Although this patent publication suggests a system for reducing the time for ordering and billing time, the time spent by the customer on the table during and after eating may not be reduced using the device of the patent.

US20050200455, a US publication describes a pager or other wireless communication device to keep participants of a queue informed of remaining wait time. An estimate of wait time is generated by a host management application using information concerning availability of a resource, for example, restaurant tables. The wait time is transmitted to each respective pager within the transmitting range of a base station. For positions high in the queue, a chit bearing an estimated return time may be issued in lieu of a pager. The chit may be returned in exchange for a pager after the return time has passed. Advertising messages may also be transmitted to the pagers, and one or more games may be played using the pagers. Pagers may be at least partially disabled when out of range of a transmitter base station. Although this patent publication suggests managing customers in the queue, it does not suggest reducing the wait time of the customers in the queue.

JP2005209040, Japanese Publication suggests an apparatus and method for ordering food and drink based on the attributes of customers and information on the number of persons, a potential order transfer means is provided on the kitchen room side for transmitting, through a control means, average kinds and quantities of foods and drinks consumed by adults X and children Y, according to the number of adults X and the number of children Y of the customers. A potential order is transmitted to the kitchen room, before the input from the customers using an order input means. With this, wait time of the customers for requested food and drink can be reduced to the possible minimum, without much inconvenience. However, this patent does not suggest how to reduce the time spent on the table after the food is served to manage and accommodate more customers who wait in the queue.

So, there is a need to solve these and other problems in restaurants, hotels, food courts, fast food centers and similar service providing industries to manage and accommodate more customers during the peak or busy hours.

### BRIEF DESCRIPTION OF THE INVENTION

The present invention relates to a method of managing customers in restaurants and similar service providing industries. The method comprises accommodating more number of customers during peak or busy hours by providing to a customer an incentive to spend less time at a table. This reduces the wait time of customers waiting in the queue.

Preferably, the method of the present invention comprises of the following steps:

providing an incentive to a customer to spend less time at a table;

processing an incentive request from the customer to dynamically determine the type and amount of incentive to be offered; and

providing a response to the customer indicating the offered incentive.

The present invention also relates to a system for managing and accommodating more number of customers during peak or busy hours in a restaurant and similar service providing industries. The system comprises of means for providing to a customer an incentive to spend less time at a table.

Preferably, the system of the present invention comprises of:

a communicating means for providing an incentive to a customer to spend less time at a table;

a processor for processing an incentive request from the customer to dynamically determine the type and amount of incentive to be offered; and

a response means for providing a response to the customer indicating the offered incentive.

### DETAILED DESCRIPTION OF THE INVENTION

The present invention relates to a method and system of managing and accommodating customers in restaurants and similar service providing industries, such as fast food centers, food courts and hotels.

More particularly, the present invention relates to a method and system for accommodating more number of customers during peak or busy hours by providing to a customer an incentive to spend less time at a table. This reduces the wait time of customers waiting in the queue.

The incentive request is processed to dynamically determine the type and amount of incentive to be offered. The determination of type and amount of incentive to be offered to the customer is made based on the time the customer decides to spend at the table. The lesser the time a customer spends at the table, the more is the incentive offered to him. Accordingly, a response is provided to the customer indicating the offered incentive.

According to a preferred embodiment of the present invention, the method for managing and accommodating more number of customers during peak or busy hours in a restaurant, fast food center, hotel and in similar service providing industry is by providing a cash discount depending on the time parameter, that is, based on time spent by the customer on the table. The discount parameter may be planned and fixed by the managers to cater their requirement.

The cash discount may preferably be worked out according to the menu chosen by the customer. For example a menu with a soup, starter, main course, and a desert may require about half an hour to forty-five minutes for an average person to eat and enjoy the food at leisure. However, it is frequently found that customers spend more than an hour and a half to eat the above menu. This is actually the reason for the increased waiting time for customers in the queue.

The present inventors have found a novel method to address the above issues. The novel method is to provide an incentive, preferably a discount on the total amount spent based on the time spent by the customer on the table. Most often, customers realize that they spend more time on the table in a restaurant, so providing such incentives like discounts would motivate the customer to avail the discount and spend less time on the table.

Such incentives, preferably cash discounts, provided for the time spent on the table by a customer would benefit both the customers and the management of restaurant. The management may accommodate more number of customers during the peak or busy hours as the time to be spent by a customer on a table may be estimated by the discount the customer is availing. The management would also be able to provide more or less the exact time of wait to the customers in queue; this would help the customers to decide if they wish to continue waiting based on the time available to them. This would also help in reducing their dissatisfaction. So, on an average, more number of customers may be accommodated by providing such discounts than those without discounts. Waiting customers would also have to wait for substantially less time in the queue than otherwise. Customers on the table are already benefited by the incentives provided.

Less time spent by customer at the table means less money spent and vice-versa. Thus the invention is useful, as it provides a method and system of accommodating more number of customers during peak or busy hours, reducing wait of customers and providing customer satisfaction in restaurants and similar service providing industries.

In case of cash discount incentives, fixed menu, such as quick lunch, combo lunch, combo menu, etc may be designed to a limited time to eat with the cash discounts. Coffee shops, salad bars, fruit bars, etc may also provide such discounts on respective set of choices. This would minimize the time spent by the customer on the table which in turn helps the management to accommodate more number of customers during a specific period of time.

Discount may be dynamically planned according to the requirement, location, season, peak time, type of restaurant, fast food center, hotel, and expected number of customers during a period of time and other parameters that a person skilled in the art may arrive at with the teachings of the invention.

It should be understood that the percentage of discount provided for a specific period of time may be determined by the person skilled in the art. It should be further understood that the percentage of discount will be more for lesser time spent by the customer on a table for a menu chosen by the customer.

In an aspect of the invention, customers who take more time, than which is allotted to them as per their discount chosen, may loose a part of their discount. This loss in discount may be as per the schedule fixed by the service provider. Thus, the more a customer stays, the more he moves towards the full payment.

Similarly, it is also provided that customers, who do not get their turn for the meal at the allotted time, may be granted compensation by the service provider. This compensation may be in any form, such as a complimentary addition to their order, a free meal, or a cash discount. It may also be understood that, for example, the cash discount given to such a customer may be recovered by the service provider from the customer who exceeded his time limit, by providing an equivalent cut in his discount.

For example, if a customer opts for a 20% discount for spending 30 minutes and instead spends 45 minutes, he may loose 10% of his discount. This discount may then be passed on to the waiting customer who was delayed due to the first customer.

To efficiently work out the present invention, the restaurant may also introduce or use devices, systems, and methods of ordering and the like as described in prior arts to reduce the wait time of ordering, billing and the like in combination with the present invention.

The method of managing customers during peak or busy hours by providing discount based on time spent on the table may further include providing a discount for the time spent on the table for a Buffet for accommodating more number of customers at a time. According to the present invention, the discount is a cash discount based on the time spent on the table for a Buffet.

According to an example of the preferred embodiment of the present invention, for a Buffet, a 10% discount is given if a customer spends 20 minutes on the table and a 20% discount is given if the customer spends 15 minutes on the table. It should be understood that generally Buffet is provided for a fixed price and a general buffet menu may include a soup, starter, salads, main course, and deserts. The customer has a set of options for a fixed price. Therefore, the discount provided may be planned by the management accordingly to suit their needs.

According to an aspect, the present invention includes a method for managing customers during peak or busy hours by providing a discount based on time spent on the table may further include providing a discount for a time spent on the table for a La Carte for accommodating more number of customers at a time. According to the present invention, the discount is a cash discount based on the time spent on the table for a La Carte.

As another example of the preferred embodiment, for a La Carte a customer may be charged an X amount if a customer spends an hour on the table after the food is served. A 10% discount may be provided on X amount if the customer spends 45 minutes and a 20% discount may be provided on X amount if the customer spends only 30 minutes on the table after the food is served. The X amount may vary with the menu that the customer chooses.

Alternatively, for a La Carte, for a fixed minimum amount a customer should spend that is say for example Y amount, a 10% discount be provided to the customer if he spends less than an hour, for example 45 minutes. A 20% discount may be provided if the customer spends only 30 minutes on the table after the food is served. The Y amount may be planned and worked out by the management according to the requirement

It should be understood that the percentage of discount may vary with other parameters such as profit percentage, type of food, location of the restaurant, and the like.

The method of managing customers during peak or busy hours by providing discount parameter based on time spent on the table may further include providing a discount for the time spent on the table for a fixed menu.

An example would be a fixed menu, such as a quick lunch menu including for example a sandwich, a salad, and soup. The quick lunch menu may be according to the region, location, choice of the customers and various other parameters. Such fixed menu may be served at a discount of 10% for 20 minutes and more discount may be provided depending on various other factors such as type of food, profit percentage, expense, and the like.

Combo meal, combo lunch and the like generally available at fast food centers like McDonalds, Burger King, Pizza Huts, food court and other restaurants may also be available with a cash discount to the customers to reduce the time spent by the customer on the table based on the crowd, wait time and dissatisfaction of customers. This would ease accommodating more number of customers during peak or busy hours that will substantially increase the revenue of the restaurant as well.

Such a method for managing customers during the peak or busy hours in restaurants, hotels, fast food centers and other similar service providing industries would provide customer satisfaction and substantially effective management of customers.

The customers who avail the discounts based on the time spent on the table would be satisfied as the customer spends less money than usual.

For the restaurant managers, such method of managing customers by providing discounts based on the time spent on the table would be beneficial in many ways such as accommodating more customers during the period of time there by increased revenue, customer satisfaction, and the like. Moreover, it gives a liberty to the restaurant manager to even politely inform the customer about the time-spent discount, easing the management of the customers without any dissatisfaction which otherwise is substantially difficult in a service industry like restaurants, fast food centers, and hotels.

In an alternative aspect of the invention, the incentive offered to a customer may be in the form of a reward, such as a free dessert or drink, or the like.

According to another aspect, the invention provides a system to implement the method of managing and accommodating customers during peak or busy hours by providing incentive based on time spent on the table.

The system comprises of a means for communicating to the customers, about the incentives offered to spend less time at a table. One way of making the customer aware is by providing a menu card to the customer on entering the restaurant and explaining the discount or offer provided to him. Other systems include display at the entry of the restaurant and similar service providing industries, making advertisements etc commonly known to people in the art.

If the customer avails of the incentive, his request are processed to dynamically determine the type and amount of incentive to be offered. A processor such as a computer, calculator or any mechanical or electronic processor may be used for the purpose. On determination of the incentive, a response is then provided indicating the same.

The system may also be a website for the restaurant and similar service providing industries, which enables the customers to make their reservations beforehand. During this process, the customers can be made aware of the incentives provided. The customers can then indicate their choice based on the time they would like to spend on their table; accordingly the system will calculate the incentive and display it for the customer.

In an embodiment, the system can be a website where, along with other functions, like advertisement of the restaurant, reservations etc., it is also used to communicate to the potential customers the existing scheme for incentives. A customer can access the home page of the website by any common access method, like for e.g. keying in URL, accessing through search engines etc. The website generally has a plurality of tabs, such as Home, About us, Location, Reservation, etc. The tabs may be on the home page as well as on each page. A communicating means such as a display module indicating the incentives offered is prominently displayed on the page. It may be present on each page, or only on the reservations page. On entering the display module the customer is made aware of the incentives offered in detail.

In a preferred embodiment, incentive offered is a discount on the total charges of dining. For example, the display module may indicate that for dining at peak hours, the customer may get a discount for occupying a table for a limited period of time, such as 10% discount for occupying the table for 45 minutes. The display also indicates the maximum amount of discount that a customer can avail of and a statement that if the customer overshoots the time limit indicated by him, he may forfeit his discount.

If the customer agrees to avail of the incentives offered, the system comprises an input module where the customer indicates the time he will occupy a table and the discount he will avail. The input module conveys the data to a processor. The processor processes the input data and determines the discount that the customer is entitled to. The processor may also have certain variables programmed into it, e.g. time of year, holiday seasons, inflation etc. The restaurant host can alter the variables as per their requirement.

After processing, the result is displayed through the response means such as the display module. If the customer accepts the discount offered to him, he indicates his acceptance and reservation is completed. Different systems can be used for completing this process. The respective time slots may be blocked in a spreadsheet. Alternatively, a display of each table available in the restaurant is depicted graphically. As each table is reserved, it is marked accordingly, along with the duration of booking. Alternatively, the system may be a simple request system, where a customer requests a reservation; the request is transmitted to the host, who responds to the request within a specific period of time.

In view of the description, other embodiments and uses of the invention will be apparent to those skilled in the art and the same may be varied in many ways without departing from the spirit of the invention. All such modifications are included within the scope of the invention.

1. A method of managing customers in a restaurant and similar service providing industries, said method comprising accommodating more number of customers during peak or busy hours by providing to a customer an incentive to spend less time at a table.

2. A method of managing customers in a restaurant and similar service providing industries, said method comprising accommodating more number of customers during peak or busy hours by providing to a customer an incentive to spend less time at a table and thereby reducing the wait time of customers waiting in the queue.

3. The method of claim 1, comprising the steps of:
providing an incentive to a customer to spend less time at a table;
processing an incentive request from the customer to dynamically determine the type and amount of incentive to be offered; and
providing a response to the customer indicating the offered incentive.

4. The method of claim 3, wherein the determination of type and amount of incentive to be offered to the customer, is made based on the time the customer decides to spend at the table.

5. The method of claim 4, wherein the lesser the time a customer spends at the table, the more is the incentive offered to him.

6. The method of claim 1, further comprising designing a menu to be eaten in a limited time for the customer availing of the incentive.

7. The method of claim 6, wherein the menu is a special menu such as a fixed menu, quick menu or a combo lunch.

8. The method of claim 2, further comprising giving an estimate to the waiting customer of the remaining wait time, based on the time decided by the seated customer.

9. The method of claim 1, wherein the incentive is a cash discount.

10. The method of claim 9, wherein the lesser the time a customer spends at the table, the lesser is the money spent by him.

11. The method of claim 9, further comprising reducing the cash discount as the customer exceeds his indicated time.

12. The method of claim 9, further comprising fixing of a minimum price that a customer has to pay, regardless of the time he spends at the table.

13. The method of claim 1, wherein the type of service offered is a buffet service.

14. The method of claim 1, wherein the type of service offered is a La Carte.

15. The method of claim 1, wherein the type of service offered is a fixed menu.

16. The method of claim 1, wherein the incentive is in the form of a reward, selected from a free dessert, a free drink or a coupon.

17. A system for managing and accommodating more number of customers during peak or busy hours in a restaurant and similar service providing industries, said system comprising means for providing to a customer an incentive to spend less time at a table.

18. The system of claim 17 comprising:
a communicating means for providing an incentive to a customer to spend less time at a table;
a processor for processing an incentive request from the customer to dynamically determine the type and amount of incentive to be offered; and
a response means for providing a response to the customer indicating the offered incentive.

19. The system of claim 18, wherein the determination of type and amount of incentive to be offered, is made based on the time the customer decides to spend at the table.

20. The system of claim 17, wherein the system is selected from a menu card, a display, an advertisement and a website.
